(19) United States
(12) Patent Application Publication
(10) Pub. No.: US 2024/0388916 A1
(43) Pub. Date: Nov. 21, 2024

(54) SYSTEM AND METHOD FOR AUTOMATIC SELECTION OF CARRIER PROFILES IN A MOBILE PHONE

(71) Applicant: QUALCOMM Incorporated, San Diego, CA (US)

(72) Inventors: Sridhar BHARADWAJ, Bengaluru (IN); Vijayakumar REDDY, Hyderabad (IN); Prashanth MOHAN, Chennai (IN)

(21) Appl. No.: 18/317,138

(22) Filed: May 15, 2023

(51) Int. Cl. H04W 12/37; H04W 12/42

(52) U.S. Cl. CPC H04W 12/37; H04W 12/42

(57) ABSTRACT

Methods for automated profile selection on a carrier-locked computing device may include detecting carrier profiles stored on an electronic subscriber identity module (eSIM) and enabling use of the computing device with a carrier profile that satisfies a carrier personalization policy in response to identifying an active carrier profile that violates a carrier personalization policy. The methods may enable use by automatically deactivating any active carrier profile that violates the carrier personalization policy and automatically activating an inactive carrier profile that satisfies the carrier personalization policy.

### BACKGROUND

A computing device (e.g., user operating a user equipment (UE)) within a telecommunications network may set preferences to transmit and receive wireless data according to one or more telecommunications standards or protocols. A UE may be configured to prioritize one or more Radio Access Technologies (RATs) including 2G, 3GPP Long Term Evolution, LTE, 3G, 4G, 5G (e.g., NR), Global System for Mobile Communications (GSM), Code Division Multiple Access (CDMA), Wideband CDMA (WCDMA), Worldwide Interoperability for Microwave Access (WiMAX), Time Division Multiple Access (TDMA), and other mobile telephony communication technologies cellular RATs. A UE may also be configured to connect to multiple different wireless carriers (e.g., T-MOBILE) that utilize one or more of these RATs. A UE may connect or authenticate with a RAT via an electronic subscriber identity module (eSIM). A carrier may lock a UE so that only eSIMs personalized for its network may function with the UE.

### SUMMARY

Various aspects include methods that may be implemented on a processor of a user device (UE) for automatic activation and deactivation of a carrier profile that is stored on an eSIM of a locked UE. Various aspects may include detecting carrier profiles stored on an electronic subscriber identity module (eSIM), and enabling use of the computing device with a carrier profile stored on the eSIM that satisfies a carrier personalization policy of the computing device in response to identifying an active carrier profile that violates the carrier personalization policy.

Some aspects may further include automatically deactivating any active carrier profile stored on the eSIM that violates the carrier personalization policy, and notifying a user of the computing device that the carrier profile is being deactivated. In some aspects, automatically deactivating an active carrier profile that violates the carrier personalization policy may include setting a value in non-volatile memory on the eSIM, wherein the value corresponds to a particular carrier profile and indicates that carrier profile is inactive.

Some aspects may further include automatically activating any inactive carrier profile stored on the eSIM that satisfies the carrier personalization policy. In some aspects, automatically activating an inactive carrier profile that satisfies to the carrier personalization policy includes storing a value in non-volatile memory on the eSIM, in which the value corresponds to a particular carrier profile and indicates that carrier profile is active.

Some aspects may further include determining whether any carrier profile satisfies or violates the carrier personalization policy by comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier.

In some aspects, the eSIM may be an embedded universal integrated circuit card (eUICC). In some aspects, the eSIM may be a multiple enabled profile (MEP)-capable circuit.

Further aspects may include a processor for use in automated activation or deactivation of carrier profiles and configured to perform operations of any of the methods summarized above. Further aspects may include a carrier profile management system for automated activation or deactivation of carrier profiles and configured with processor-executable instructions to perform operations of any of the methods summarized above. Further aspects may include automated activation or deactivation of carrier profiles including means for performing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a functional block diagram of an example computing device suitable for implementing various embodiments.

FIG. 4 is a component block diagram illustrating an example system suitable for implementing various embodiments.

FIG. 5A is a process flow diagram illustrating a method 500 for automatic carrier profile adjustment according to some embodiments.

FIG. 5B is a process flow diagram illustrating a method 501 for automatic carrier profile adjustment according to some embodiments.

FIG. 6 is a process flow diagram illustrating a method 600 for automatic carrier profile adjustment according to some embodiments.

FIG. 7 is a component block diagram illustrating an example user equipment suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and user equipment (UE) implementing such methods for automatic activation and deactivation of a carrier profile that is stored on an electronic subscriber identity module (eSIM) in a locked UE (i.e., a UE that is configured with a carrier personalization policy to only operate using a carrier profile of a specific carrier). In various embodiments, a processor of a computing device may detect carrier profiles stored on an eSIM, and enable use of the UE with a carrier profile that satisfies a carrier personalization policy in response to identifying an active carrier profile that violates a carrier personalization policy. This functionality differs from the current state of the art in which the presence of any unauthorized carrier profile prompts the UE to disable or otherwise block or prevent all usage. The processor may enable use of the UE by these methods where such use includes or does not include connection to a wireless carrier and may include one or more actions to prevent locking of the UE or disabling of the UE.

Some embodiments may include automatically deactivating any active carrier profile that violates the carrier personalization policy and notifying a user of the UE that that carrier profile is being deactivated. The UE may automatically activate an inactive carrier profile that satisfies the carrier personalization policy to enable use of the UE. Deactivating of an inactive carrier profile that violates the carrier personalization policy may include setting a value in non-volatile memory on the eSIM, in which the value corresponds to a particular carrier profile and indicates that carrier profile is inactive.

Some embodiments may include determining whether any carrier profile satisfies or violates the carrier personalization policy and comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier. The eSIM may be an eUICC or a multiple enabled profile (MEP) SIM.

The terms “computing device” and “mobile device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

The term “system on chip” or the abbreviation “SOC” are used herein interchangeably to refer to a set of interconnected electronic circuits typically, but not exclusively, including a processor, a memory, and a communication interface. A processor may include a variety of different types of processors and processor cores, such as a general purpose processor, a central processing unit (CPU), a digital signal processor (DSP), a graphics processing unit (GPU or GFX), an accelerated processing unit (APU), a secure processing unit (SPU), a network processor, neural network processing unit (NPU), double data rate (DDR) memory, a subsystem processor of specific components of the computing device, such as an image processor for a camera subsystem or a display processor for a display, an auxiliary processor, a single-core processor, a multicore processor, a controller, a microcontroller, and the like. A processor may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

As used herein, the terms “network,” “system,” “wireless network,” “cellular network,” and “wireless communication network” may interchangeably refer to a portion or all of a wireless network of a carrier associated with a wireless computing device and/or subscription on a wireless computing device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Global System for Mobile Communications (GSM) Enhanced Data rates for GSM Evolution (EDGE). In another example, an OFDMA network may implement Evolved UTRA (E-UTRA), IEEE 802.11 (Wi-Fi), IEEE 802.16 (WiMAX), IEEE 802.20, Flash-OFDM, etc. Reference may be made to wireless networks that use Long Term Evolution (LTE) standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in various embodiments.

The term eSIM used herein may include an embedded universal integrated circuit card (eUICC), a multiple enabled profile (MEP)-capable embedded circuit, or related hardware, software, and firmware. The term carrier used herein may describe a wireless service provider delivering bandwidth to users and may include network bandwidth resellers (e.g., CRICKET wireless) and providers of wireless communication networks as described above (e.g., AT&T).

A UE may include digital or electronic SIMs that store codes and parameters for different wireless carriers that allow for connection to the networks of these wireless carriers. These eSIMs may be downloaded or loaded via wired connection to the UE. The eSIM may be scanned or read as part of the boot process to detect active profiles and determine whether the UE is locked or personalized by a particular carrier. The boot process of a UE may be performed by hardware and firmware that ensures security before a user is able to interact with the device. Accordingly, upon boot, an eSIM profile may be evaluated against one or more carrier policies on the phone for security, authorization or status (e.g., active or inactive).

A UE may include a multiple enabled profile (MEP)-capable embedded circuit as one or more eSIMs. A UE that is configured to read and use MEP eSIMS may be configured to connect to multiple carriers and/or connect to a carrier via multiple carrier profiles. Using the multiple enabled profiles (MEPs), the UE may connect via one carrier profile to a first carrier and may connect via another carrier profile to a second carrier simultaneously. A MEP eSIM may be an eUICC or other eSIM with these capabilities. The MEP eSIM may be read and modified by firmware of the UE during the boot process and thereafter. This firmware may be firmware of the wireless modem of the UE that connects to the wireless network via a transceiver. During boot, the reading and modifying configurations or attributes of the eSIM may be performed automatically for security reasons.

Upon boot, the boot process of the UE may identify one or more active carrier profiles on one or more eSIMs and the boot process may evaluate these carrier profiles against a carrier policy that prevent use of other carrier profiles. When an active carrier profile violates a carrier policy that locks or restricts use of a UE with different carriers, the boot process may lock a user out of the phone or may prevent any network connections. This user lock out may be an excessive restriction in order to enforce the policy of restricting a UE to a single carrier. For example, a user may wish to only use a UE over WI-FI. Further, a complete user lock may require inefficient manual resetting at a retail location. Thus, an automatic lock out of the UE due to a carrier profile in violation of a carrier policy on the phone may be inefficient and excessive for many situations.

To overcome the disadvantages of conventional computing device (such as smart phones or UEs) that are locked to a particular service provider by a carrier personalization policy, various embodiments include methods that enable such a computing device to be activated even if there is a carrier profile stored on an eSIM that violates such a policy provided there is at least one acceptable service policy stored on the eSIM. During the boot process, if a noncompliant carrier policy (i.e., violating the carrier personalization policy) is stored on the eSIM, a processor of the computing device continues to scan the eSIM to identify a carrier policy that complies with that policy (i.e., is associated with or approved poor use by the particular service provider). If a compliant carrier policy is identified, the processor enables service using the identified compliant carrier policy while taking actions to prevent use of the computing device with noncompliant carrier policies. In some embodiments, the processor may also automatically activate any inactive carrier profile stored on the eSIM that satisfies the carrier personalization policy.

In some embodiments, actions to prevent use of the computing device with noncompliant carrier policies may include deactivating any carrier policy that is found to be noncompliant with the carrier personalization policy. Deactivating a carrier policy may involve storing information on the eSIM that indicates the carrier policy is inactive or deactivated, which may include setting a flag or other value in a register in the eSIM that is checked during boot process to indicate that the policy is inactivated. Additionally, the processor may perform actions to notify a user of the computing device that a noncompliant carrier policy is being deactivated, such as via a notification on a graphical user interface (GUI). Such a notification may give the user options for responding to such automatic deactivation.

Various embodiments improve the management and application of carrier policies to carrier profiles of a UE. Various embodiments improve the boot process and modem firmware of the UE to enable automatic activation of carrier profiles that match a policy on the UE and enable automatic deactivation of carrier profiles that violate a policy on the UE. Various embodiments improve the boot process to modify values in a carrier profile to enable a user to use the UE after boot and enable use after a reboot without modification of the carrier profile.

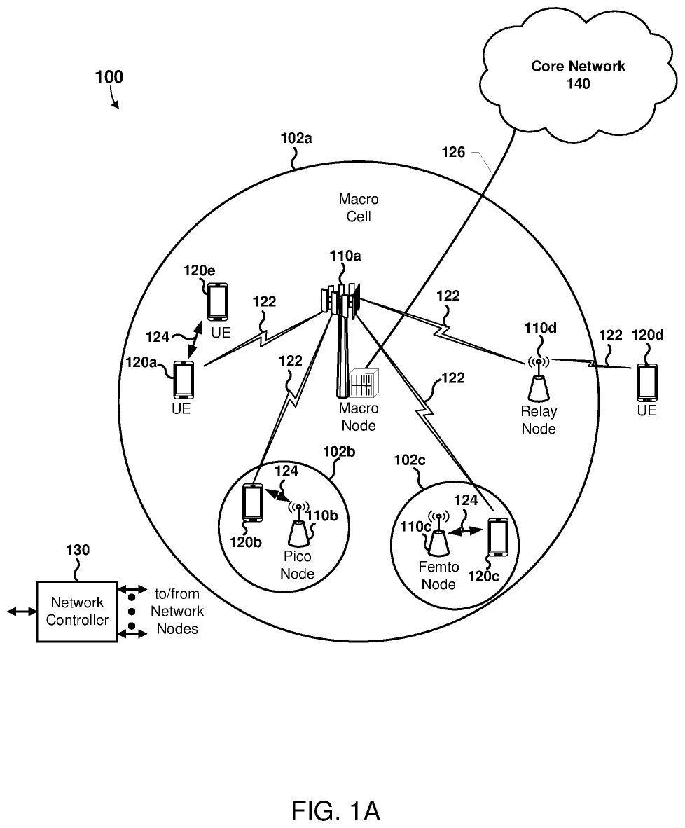

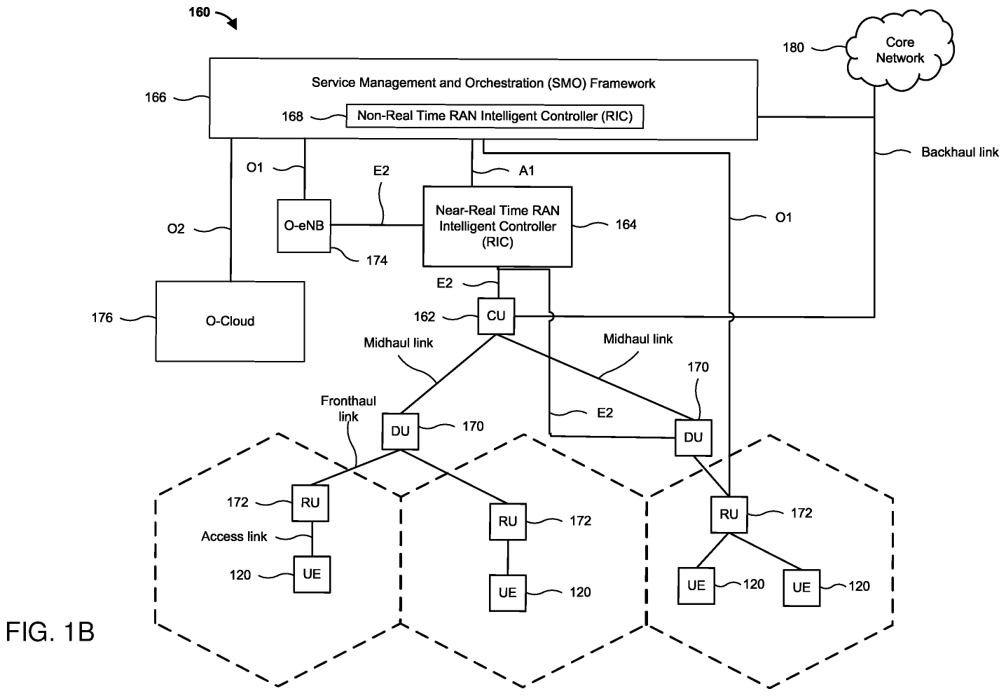

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported. Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

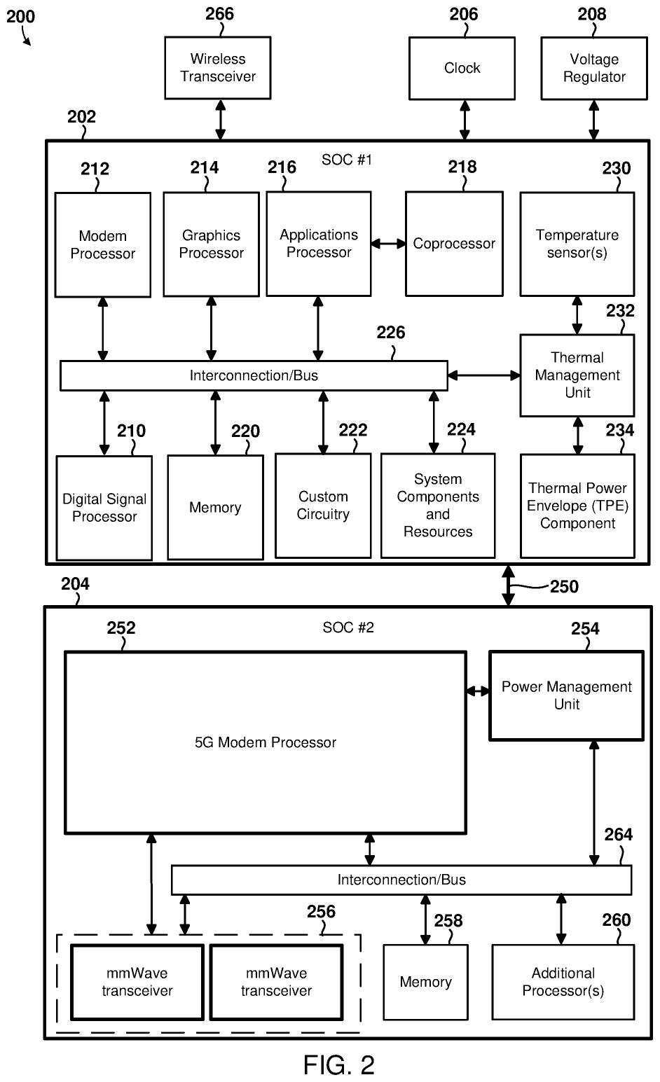

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) is suitable for use a UE (e.g., 120a-120e). The illustrated example computing system 200 includes two SOCs 202, 204 coupled to a clock 206, a voltage regulator 208, and a wireless transceiver 266 configured to send and receive wireless communications via an antenna (not shown) to/from a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wavelength (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

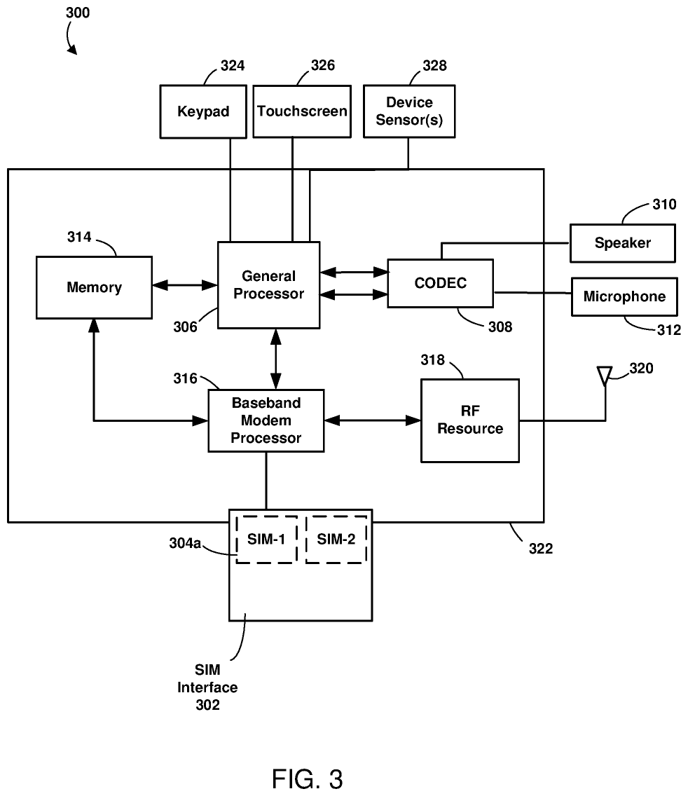

FIG. 3 is a functional block diagram of an example computing device 300 suitable for implementing various embodiments. With reference to FIGS. 1A-3, the computing device 300 may be similar to the computing device 100. For example, the computing device 300 may be a multiple subscriber identity module (SIM) computing device, such as a multi-SIM multiple standby (MSMS) computing device or multiple profile enabled (MEP) SIM. The computing device 300 may include at least one SIM interface 302, which may receive a first SIM (“SIM-1”) 304a that is associated with a first subscription. In some embodiments, the at least one SIM interface 302 may be implemented as multiple SIM interfaces 302, which may receive at least a second SIM (“SIM-2”) that is associated with at least a second subscription.

A SIM in various embodiments may be a Universal Integrated Circuit Card (UICC) that is configured with an electronic SIM (eSIM) and/or universal SIM (USIM) applications, enabling access to a variety of different networks. The UICC may also provide storage for a phone book and other applications. In a code division multiple access (CDMA) network, a SIM may be a UICC removable user identity module (R-UIM) or a CDMA subscriber identity module (CSIM) on a card. While a single SIM may connect to different networks, the subscription of the SIM may correspond to a single carrier or conglomerate of carriers.

Each SIM 304a may have a CPU, ROM, RAM, EEPROM and I/O circuits or may be configured as an electronic profile stored on computing device 300 or the baseband modem processor 316. One or more of the first SIM 304a and any additional SIMs used in various embodiments may contain user account information, an international mobile station identifier (IMSI), a mobile country code (MCC), a mobile network code (MNC), a set of SIM application toolkit (SAT) commands and storage space for phone book contacts. One or more of the first SIM 304a and any additional SIMs may further store home identifiers (e.g., a System Identification Number (SID)/Network Identification Number (NID) pair, a Home PLMN (HPLMN) code, etc.) to indicate the SIM's network operator/provider or carrier. An Integrated Circuit Card Identity (ICCID) SIM serial number may be printed on one or more SIM 304a for identification. In some embodiments, additional SIMs may be provided for use on the computing device 300 through a virtual SIM (VSIM) application that may be a part of the baseband modem processor 316 or SIM interface 302. For example, the VSIM application may implement downloaded SIMs on the computing device 300 by provisioning corresponding eSIM profiles in secure firmware.

The computing device 300 may include at least one controller, such as a general-purpose processor 306, which may be coupled to a coder/decoder (CODEC) 308. The CODEC 308 may in turn be coupled to a speaker 310 and a microphone 312. The general-purpose processor 306 may also be coupled to at least one memory 314. The memory 314 may be a non-transitory tangible computer readable storage medium that stores processor-executable instructions. For example, the instructions may include routing communication data relating to a subscription though the transmit chain and receive chain of a corresponding baseband-RF resource chain. The memory 314 may store operating system (OS), as well as user application software and executable instructions. The general-purpose processor 306 and memory 314 may each be coupled to at least one baseband-modem processor 316. Each SIM 304a in the computing device 300 may be associated with a baseband-RF resource chain that includes at least one baseband-modem processor 316 and at least one radio frequency (RF) resource 318. The baseband-modem processor 316, the radio frequency (RF) resource 318, and the antenna(s) 320 may be configured for multiple simultaneous connections (multi-connect) and may operate with multiple carriers corresponding to multiple enabled profiles (MEPs) provided via SIM interface 302.

The RF resource 318 may include receiver and transmitter circuitry coupled to at least one antenna 320 and configured to perform transmit/receive functions for the wireless services associated with each SIM 304a of the computing device 300. The RF resource 318 may implement separate transmit and receive functionalities, or may include a transceiver that combines transmitter and receiver functions. The RF resource 318 may be configured to support multiple radio access technologies/wireless networks that operate according to different wireless communication protocols. The RF resource 318 may include or provide connections to different sets of amplifiers, digital to analog converters, analog to digital converters, filters, voltage controlled oscillators, etc. Multiple antennas 320 and/or receive blocks may be coupled to the RF resource 318 to facilitate multimode communication with various combinations of antenna and receiver/transmitter frequencies and protocols (e.g., LTE, Wi-Fi, Bluetooth and/or the like).

The baseband-modem processor of a computing device 300 may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof—which is also called carrier personalization.

In some embodiments, the general-purpose processor 306, memory 314, baseband-modem processor 316, and RF resource 318 may be included in a system-on-chip device 322. The SIMs 304a and their corresponding interface(s) 302 may be external to the system-on-chip device 322. Various input and output devices may be coupled to components of the system-on-chip device 322, such as interfaces or controllers. Example user input components suitable for use in the computing device 300 may include, but are not limited to, a keypad 324, a touchscreen 326 (e.g., 102a), such as a beveled edge touchscreen.

In some embodiments, the general-purpose processor 306 may be coupled to one or more device sensors 328. The device sensor(s) 328 may provide an output that includes information about the environment around the computing device 300. For example, the computing device may include an ambient light sensor configured to sense and intensity of ambient light incident on the ambient light sensor, and to provide an output to the general-purpose processor 306 including information about the intensity of the ambient light.

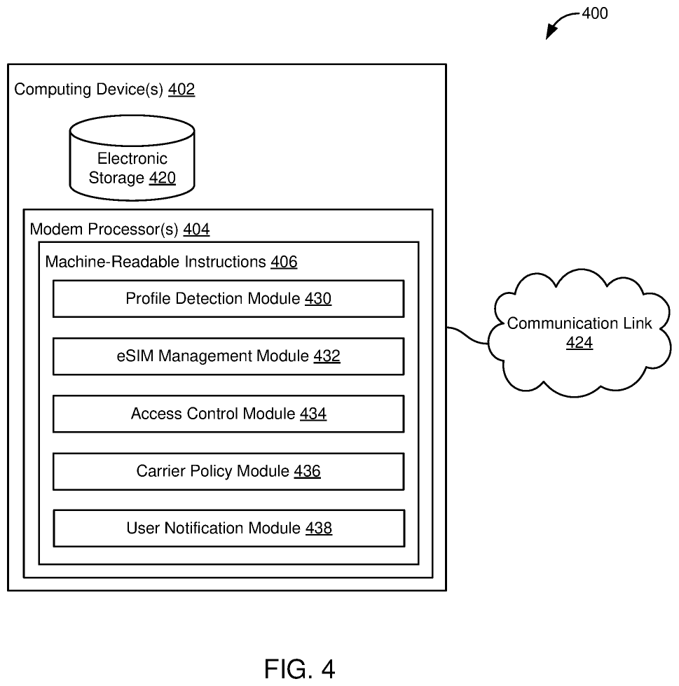

FIG. 4 is a component block diagram illustrating an example system 400 for automatically activating or deactivating one or more carrier profiles to optimize use thereof according to some embodiments. With reference to FIGS. 1A-4, the system 400 may include one or more computing devices 402 and one or more carriers, which may provide a wireless communication link 424. The system 400 may include a plurality of hardware, software, and/or firmware components operating together to provide the functionality attributed herein to the processor(s) 422. The modem processor(s) 404 may manage electronic communication over the communication link 424 according to machine-readable instructions 406. The machine-readable instructions 406 may relate to trusted applications provisioned on the computing device 402 and authenticated by certificate as part of the boot process to ensure security of the computing device 402. Further aspects of these machine-readable instructions 406 are described below.

The computing device 402 may include electronic storage 420 that may be configured to store information related to functions implemented by a profile detection module 430, an eSIM management module 432, an access control module 434, a carrier policy module 436, a user notification module 438, and any other instruction modules. The electronic storage 420 may include one or more carrier profiles or eSIMs that have been downloaded or installed by a user or a retailer. The carrier profile may include one or more wireless communication configurations, one or more IMSI numbers, one or more multi-connectivity configurations, and other attributes (e.g., serial number). The carrier profile may include one or more variables (e.g., flag) that indicate whether the carrier profile is active or inactive. The electronic storage 420 may store one or more carrier policies that define which wireless carriers can be used with the computing device 402, which wireless protocols can be used by the computing device 402 (e.g., CDMA), what actions to take in case of a policy violation, and a process for changing the carrier policy (e.g., signing certificate). A carrier policy may be write-protected or read-only.

The electronic storage 420 may include non-transitory storage media that electronically stores information. The electronic storage 420 may include one or both of system storage that is provided integrally (i.e., substantially non-removable) within the processor and wireless modem components 200 (e.g., within the same SoC or SIP) and/or removable storage that is removably connectable to the processor and wireless modem components 200 via, for example, a port (e.g., a universal serial bus (USB) port, a firewire port, etc.) or a drive (e.g., a disk drive, etc.). In various embodiments, electronic storage 420 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media 420. The electronic storage 420 may store software algorithms, information determined by processor(s) 422, and/or other information that enables the processor and wireless modem components 200 to function as described herein.

The computing device 402 may include a modem including a modem processor 404 configured by machine-readable instructions 406 to perform operations of various embodiments. Machine-readable instructions 406 may include one or more instruction modules. The instruction modules may include computer program modules. The instruction modules may include one or more of a profile detection module 430, a eSIM management module 432, an access control module 434, a carrier policy module 436, a user notification module 438, and other instruction modules (not illustrated).

The modem processor 404 may include one of more local processors that may be configured to provide information regarding processing capabilities in the systems 100a and 100b. As such, the modem processor 404 may include one or more of a digital processor, an analog processor, a digital circuit designed to process information, an analog circuit designed to process information, a state machine, and/or other mechanisms for electronically processing information. Although the modem processor 404 is shown in FIG. 4 as a single entity, this is for illustrative purposes only. In some embodiments, the modem processor 404 may include a plurality of processing units. These processing units may be physically located within the same device, or the modem processor 404 may represent processing functionality of a plurality of devices distributed in the processor and wireless modem components (e.g., 200).

In some embodiments, the modem processor 404 executing the profile detection module 430 may be configured to operate as part of a boot process to scan or read at least one eSIM or virtual SIM stored in non-volatile memory of the computing device 402 (e.g., electronic storage 420). The profile detection module 430 may be configured to authenticate the at least eSIM after reading it. The profile detection module 430 may communicate at least one parameter from the at least one eSIM to the eSIM management module 432, the access control module 434, the carrier policy module 436, or the user notification module 438.

In some embodiments, the modem processor 404 executing the eSIM management module 432 may be configured to receive a downloaded eSIM, install an eSIM, activate or deactivate an eSIM, delete an eSIM, and modify other eSIM parameters as allowed by their configuration. In some embodiments, the modem processor 404 executing the eSIM management module 432 may be configured to automatically deactivate any active carrier profile that violates the carrier personalization policy or automatically activate an inactive carrier profile that satisfies the carrier personalization policy. In some embodiments, the eSIM management module 432 may be configured to deactivate an inactive carrier profile that violates the carrier personalization policy by setting a value in non-volatile memory on the eSIM, where the value corresponds to a particular carrier profile and indicates that the carrier profile is inactive. In some embodiments, the eSIM management module 432 may be configured to automatically activate an inactive carrier profile that satisfies to the carrier personalization policy by storing a value in non-volatile memory on the eSIM, where the value corresponds to a particular carrier profile and indicates that the carrier profile is active.

In some embodiments, the modem processor 404 executing the access control module 434 may be configured to control access or inputs to the computing device from a variety of sources (e.g., wired, wireless, touchscreen, microphone) based on determinations made at the profile detection module 430 and the carrier policy module 436. In some embodiments, the modem processor 404 executing the access control module 434 may be configured to allow the eSIM management module 432 to make changes to a carrier profile in response to a determination to lock at least some functionality/inputs of the computing device 402. In some embodiments, the access control module 434 may be configured to disable all wireless carriers or disable wireless communication (except WI-FI or sidelink) upon a determination by the profile detection module 430 or the eSIM management module 432 that no valid carrier profile (active or inactive) is present on the computing device 402.

In some embodiments, the modem processor 404 executing the carrier policy module 436 may be configured to determine whether any carrier profile satisfies or violates a carrier personalization policy. This determination may include comparing one or more attributes of each carrier profile stored on the eSIM with the carrier personalization policy. Attributes of a carrier profile may including one or more of: an international mobile subscriber identity (IMSI), a mobile country code (MCC), a mobile network code (MNC), a carrier identifier, or a subscriber identifier. The carrier policy module may be configured to download, upload, or modify one or more carrier policies for the computing device 402. A carrier policy may instruct the access control module 434 to restrict certain functions for certain carrier profiles and may define one or more attributes or protocols for wireless transmission by a carrier profile complying with the carrier policy. The modem processor 404 executing the carrier policy module 436 may be configured to authenticate a carrier policy (e.g., with a certificate) to protect against tampering.

In some embodiments, the modem processor 404 executing the user notification module 438 may be configured to notify a user when an automatic action has been taken. For example, the access control module 434 may instruct the user notification module 438 to notify the user of a restriction placed on the functionality of the computing device 402. The access control module 434 may instruct the user notification module 438 to notify the user of an activation or deactivation of a carrier profile due to a carrier policy violation, a user action, or an external carrier action. The user notification generated by the user notification module 438 executing on the modem processor 404 may be a graphic with text, a voice or sound notification, or other alert.

The description of the functionality provided by the different modules 430-438 is for illustrative purposes, and is not intended to be limiting, as any of modules 430-438 may provide more or less functionality than is described. For example, one or more of modules 430-438 may be eliminated, and some or all of its functionality may be provided by other ones of modules 430-438. As another example, modem processor 404 may execute one or more additional modules that may perform some or all of the functionality attributed below to one of modules 430-438.

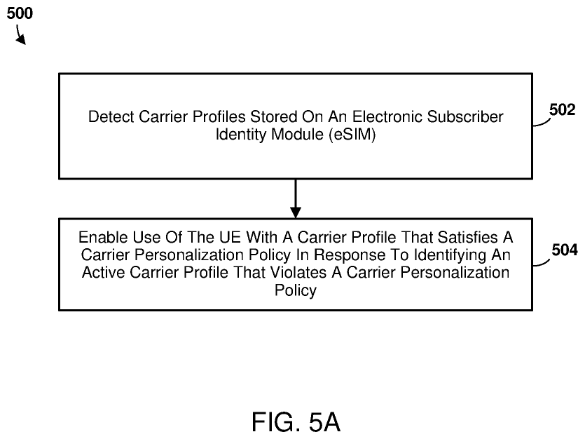

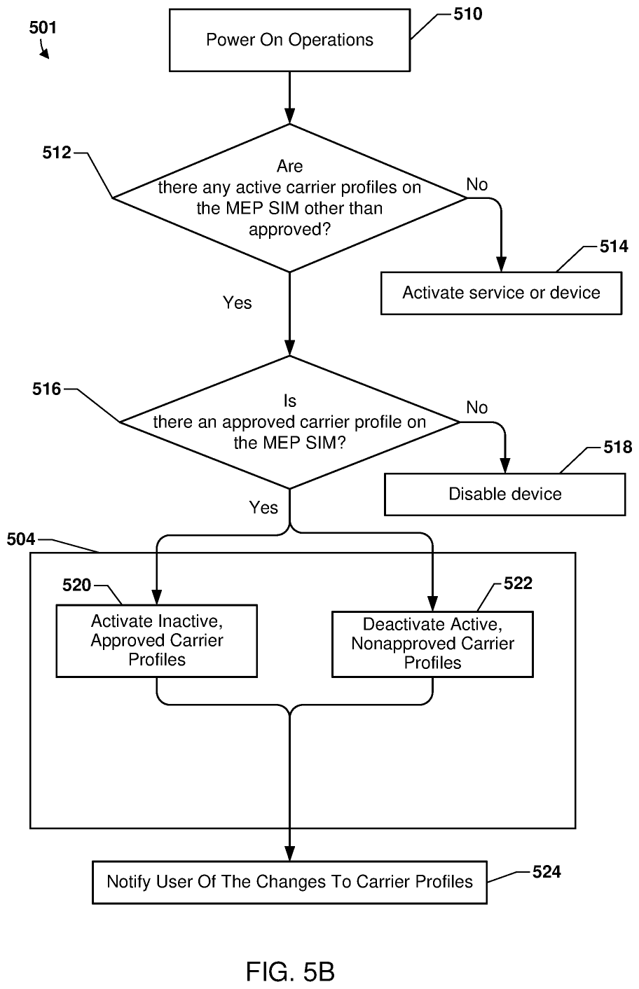

FIG. 5A is a process flow diagram illustrating an example method 500 for automatic activation and deactivation of a carrier profile that is stored on an eSIM to enable use of a computing device (e.g., a UE) when a stored carrier profile violates a carrier personalization policy. With reference to FIGS. 1A-5A, operations of the method 500 may be performed by a processor of a computing device according to various embodiments. In some embodiments, means for performing operations of the method 500 may be a processor (e.g., 202, 204, 306, 316, 404) of the computing device (e.g., 120a, 402), and/or the like.

In block 502, the processor may detect carrier profiles stored on an electronic subscriber identity module (eSIM). For example, the processor may scan an MEP eSIM and detect an AT&T carrier profile and a T-MOBILE carrier profile stored in memory. As part of the operations in block 502, the processor may also detect whether stored carrier profiles are active or inactive. In some embodiments, detecting the carrier profiles in block 502 may include determining whether any carrier profile satisfies or violates the carrier personalization policy implemented on the computing device. In some embodiments, this determination may include comparing one or more attributes of each carrier profile to the carrier personalization policy, the one or more attributes including one or more of: an international mobile subscriber identity (IMSI), a mobile country code (MCC), a mobile network code (MNC), a carrier identifier, or a subscriber identifier. The eSIM may be an embedded universal integrated circuit card (eUICC) or the eSIM may be a multiple-enabled profile (MEP)-capable circuit.

In block 504, the processor may enable use of the computing device (e.g., UE) using an active carrier profile stored on the eSIM that satisfies the carrier personalization policy in response to identifying that there is an active carrier profile that violates the carrier personalization policy. In other words, rather than preventing operation of a UE in which the eSIM includes a carrier profile violating the carrier personalization policy as in conventional UE's, the processor may activate and provide service using a carrier policy that satisfies the carrier personalization policy.

In some embodiments, enabling use of the computing device (e.g., UE) using a carrier policy that satisfies the carrier personalization policy in block 504 may include automatically deactivating any active carrier profile stored on the eSIM that violates the carrier personalization policy. In some embodiments, operations performed in block 504 of automatically deactivating an active carrier profiles that violates the carrier personalization policy may include setting a value in non-volatile memory on the eSIM (e.g., 304a) that corresponds to the deactivated carrier profile and indicates that the carrier profile is inactive, such as during a boot process.

In some embodiments, operations performed in block 504 may also include automatically activating an inactive carrier profile that satisfies the carrier personalization policy. In some embodiments, operations performed in block 504 of automatically activating an inactive carrier profile that satisfies the carrier personalization policy may include storing a value in non-volatile memory on the eSIM (e.g., 304a) that corresponds to the activate carrier profile and indicates that the carrier profile is active, such as during a boot process.

FIG. 5B is a process flow diagram of an example method 501 illustrating further operations involved in enabling use of a computing device (e.g., UE) with a carrier profile that violates the personalization policy including automatic activation and deactivation of a carrier profile that is stored on an eSIM. With reference to FIGS. 1A-5B, operations of the method 501 may be performed by a processor of a computing device according to various embodiments. In some embodiments, means for performing operations of the method 501 may be a processor (e.g., 202, 204, 306, 316, 404) of the computing device (e.g., 120a, 402), and/or the like.

In block 510, the processor may perform power-on operations of the computing device. The processor may execute one or more firmware instructions as part of a boot process to initialize the device. The boot process and power-on of the computing device may be a secure or trusted process that is tamper proof. The boot process may include initiating hardware and firmware of a modem processor (e.g., modem processor 404).

In determination block 512, the processor may read the personalization policy of the computing device, read the carrier profiles stored on an eSIM (e.g., a MEP SIM) of the computing device, and determine whether there are any carrier profiles other than approved carrier profiles (i.e., whether any carrier profiles that violate the personalization policy). As described regarding block 502, this determination may involve comparing one or more attributes of each carrier profile to the carrier personalization policy, and recognizing when a carrier profile attribute is inconsistent with the carrier personalization policy of the computing device. For example, the processor may determine that there is a nonapproved carrier profile stored on the MEP SIM if the carrier personalization policy of the computing device only approves of a first wireless carrier (e.g., T-MOBILE) and the processor determines that a carrier profile corresponding to a second wireless carrier (e.g., AT&T) that violates the personalization policy is stored on the MEP SIM.

In response to determining that there are no carrier profiles stored on the MEP SIM that violate the carrier personalization policy of the computing device (e.g., UE 120a) (i.e., determination block 512=“No”), the processor may enable use of the computing device using one of the approved carrier profiles (i.e., a carrier profile that complies with the carrier personalization policy) in block 514. Depending on the timing of the boot process of the rest of the computing device, the activation of the computing device in block 514 may progress with a boot process that allows the user to use the computing device without restrictions. Activation of service under the approved carrier profile may allow connection to a wireless network of that carrier.

In response to determining that there is at least one carrier profile stored on the MEP SIM that is not approved (i.e., determination block 512=“Yes”), the processor may check whether there is an approved carrier profile stored on the MEP SIM (active or inactive) in determination block 516. For example, in determination block 516 further analysis of the carrier profiles may be performed because unapproved carrier profiles have been found in block 512. This further analysis in determination block 516 may include scanning the MEP SIM for inactive or deactivated carrier profiles that comply with the carrier personalization policy.

Upon determining that no further approved carrier profiles are present (i.e., NO), then the processor may proceed to block 518. If an inactive approved carrier profile is identified on the computing device (i.e., YES), then the processor may progress to block 504 and blocks 520 and 522. Further, the blocks 512 and 516 may form at least a portion of the functions of block 502 of FIG. 5A.

In response to determining that there is no approved carrier profile stored on the MEP SIM (i.e., determination block 516=“No”), the processor may disable one or more functions of the computing device in block 518. For example, if the UE is carrier locked, the carrier policy may prevent access to a wireless network with an unapproved carrier profile active. Disabling various functions of the UE in block 518 (e.g., sidelink, location services) may allow the user to operate many aspects of the UE despite having carrier profiles that violate the carrier policy, while disabling the functionality that the carrier intends to prevent (e.g., using a competing wireless network).

In response to determining that there is there is an approved carrier profile stored on the MEP SIM (i.e., determination block 516=“Yes”), the processor may enable use of the UE or computing device with a carrier profile in as block 504 described. As part of enabling use of the computing device in block 504, the processor may automatically activate any inactive and approved carrier profiles in block 520 so such carrier profiles can be used in the current or future service connections. Also as part of enabling use of the computing device in block 504, the processor may automatically deactivate any active and unapproved carrier profiles (i.e., carrier profiles that violate the carrier personalization policy as described) in block 522. As a result of the operations performed in block 520 and/or block 522, the active carrier profiles stored on the MEP SIM may comply with the carrier personalization policy of the computing device, while any other carrier profiles (i.e., violating the carrier personalization policy) will be inactive (either previously inactive or deactivated). By activating approved carrier profiles and deactivating any nonapproved carrier profiles in blocks 520 and 522, there will be no active carrier profiles stored on the MEP SIM that violate the carrier personalization policy, and therefore, the processor will immediately activate service on the computing device during the next boot process in block 514 as described.

Execution of the operations of block 520 and/or block 522 may depend on the actions available based on the carrier profiles present in order to enable the most functionality on the UE. For example, if the processor determines in determination block 516 that there is an active, approved carrier profile and an active, nonapproved carrier profile stored on the MEP SIM, only the operations in block 522 of deactivating active nonapproved carrier profiles may be performed. In another example, if the processor determines in determination block 516 that there is an inactive, approved carrier profile and an active, approved carrier profile stored on the MEP SIM, the processor may perform the operations in both block 520 and block 522. In another example, if the processor determines in determination block 516 that there is only an inactive, approved carrier profile stored on the MEP SIM, the processor may perform the operations of block 520 but not of block 522.

In block 524, the computing device may notify the user, such as via a graphical user interface (GUI) (e.g., user notification module 438), of the changes made to the carrier profiles in block 504. In an notification provided in block 524, the user may be given options to retain one or more changes and/or may be informed that one or more changes were necessary to prevent disabling of the computing device. A user may be notified of detection of an unapproved, inactive carrier profile, for example, if this is a new carrier profile. A user may be notified in block 524 that activation of one or more unapproved carrier profiles may result in automatic disabling of certain functionality (e.g., by access control module 434).

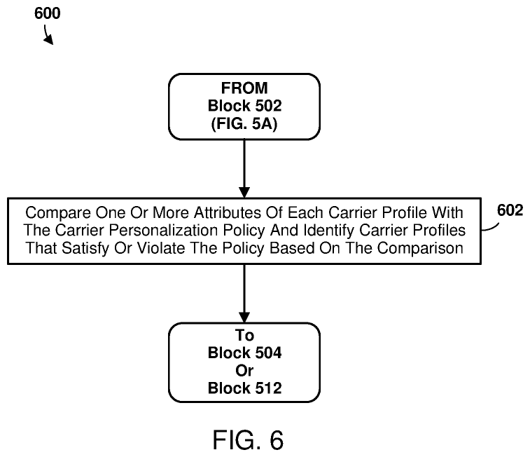

FIG. 6 is a process flow diagram illustrating an example method 600 for automatic activation and deactivation of a carrier profile that is stored on an eSIM. With reference to FIGS. 1A-6, the operations of the method 600 may be performed by a processor of a computing device according to various embodiments. In some embodiments, means for performing operations of the method 600 may be a processor (e.g., 202, 204, 306, 316, 404) of the computing device (e.g., 120a, 402), and/or the like.

After performing the operations in block 502 to detect carrier profiles stored on the MEP SIM as described, the processor may compare one or more attributes of each detected carrier profile with the carrier personalization policy in block 602. These attributes may include an international mobile subscriber identity (IMSI), a mobile country code (MCC), a mobile network code (MNC), a carrier identifier, or a subscriber identifier. A carrier profile may be determined to violate a carrier policy even if the carrier identifiers match. For example, the carrier may have blocked the IMSI number of the device due to spam calls. For example, on a smart phone locked to the carrier AT&T by the carrier personalization policy, the processor would determine that a carrier profile for T-MOBILE violates the carrier personalization policy, but a carrier profile for AT&T satisfies the carrier personalization policy.

The processor may then perform the operations to enable use of the computing device in block 504 or determine whether there are any active carrier profile on the MEP SIM other than approved in determination block 512 as described.

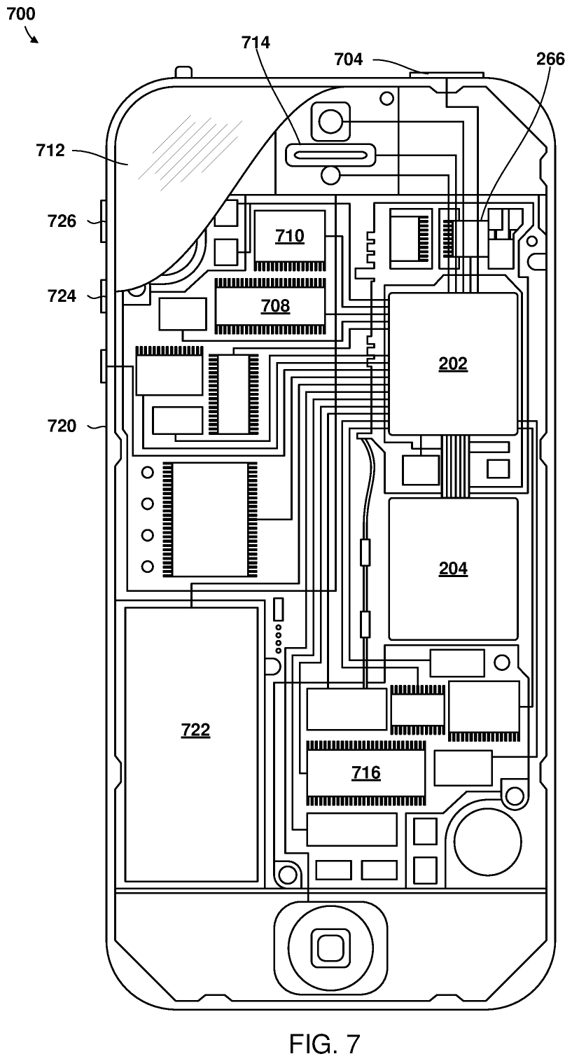

Various embodiments (including, but not limited to, embodiments described above with reference to FIGS. 1A-6) may be implemented in a variety of computing devices, an example in the form of a smart phone UE is illustrated in FIG. 7. The UE 700 may include a processor 202 coupled to a touchscreen controller and an internal memory (e.g., 314, 420). The processor 202 may be one or more multicore integrated circuits designated for general or specific processing tasks. The internal memory may be volatile or non-volatile memory and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, embedded DRAM, non-volatile flash memory, UFS, SDCC, etc. The touchscreen controller and the processor 202 may also be coupled to a touchscreen panel 712, such as a resistive-sensing touchscreen, capacitive-sensing touchscreen, infrared sensing touchscreen, etc. Additionally, the display of the UE 700 need not have touch screen capability.

The UE 700 may have one or more radio signal transceivers 708 (e.g., Peanut, Bluetooth, ZigBee, Wi-Fi, RF radio) and antennae 710, for sending and receiving communications, coupled to each other and/or to the processor 202. The transceivers 708 and antennae 710 may be used with the above-mentioned circuitry to implement the various wireless transmission protocol stacks and interfaces. The UE 700 may include a cellular network wireless modem chip 716 that enables communication via a cellular network and is coupled to the processor 202.

The UE 700 may include a peripheral device connection interface 704 coupled to the processor 202. The peripheral device connection interface 704 may be singularly configured to accept one type of connection or may be configured to accept various types of physical and communication connections, common or proprietary, such as Universal Serial Bus (USB), FireWire, Thunderbolt, or PCIe. The peripheral device connection interface 704 may also be coupled to a similarly configured peripheral device connection port (not shown).

The UE 700 may also include speakers 714 for providing audio outputs. The UE 700 may also include a housing 720, constructed of a plastic, metal, or a combination of materials, for containing all or some of the components described herein. The UE 700 may include a power source 722 coupled to the processor 202, such as a disposable or rechargeable battery. The rechargeable battery may also be coupled to the peripheral device connection port to receive a charging current from a source external to the UE 700. The UE 700 may also include a physical button 724 for receiving user inputs. The UE 700 may also include a power button 726 for turning the UE 700 on and off.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a UE including a processor (e.g., a modem processor) configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE (e.g., a modem processor) to perform the operations of the methods of the following implementation examples.

Example 1. A method for automated profile selection on a carrier-locked computing device, the method including: detecting carrier profiles stored on an electronic subscriber identity module (eSIM); and enabling use of the computing device with a carrier profile stored on the eSIM that satisfies a carrier personalization policy of the computing device in response to identifying an active carrier profile that violates the carrier personalization policy.

Example 2. The method of example 1, further including: automatically deactivating any active carrier profile stored on the eSIM that violates the carrier personalization policy; and notifying a user of the computing device that the carrier profile is being deactivated.

Example 3. The method of example 2, in which automatically deactivating an active carrier profile that violates the carrier personalization policy includes setting a value in non-volatile memory on the eSIM, in which the value corresponds to a particular carrier profile and indicates that carrier profile is inactive.

Example 4. The method of any of examples 1-3, further including: automatically activating any inactive carrier profile stored on the eSIM that satisfies the carrier personalization policy.

Example 5. The method of example 4, in which automatically activating an inactive carrier profile that satisfies to the carrier personalization policy includes storing a value in non-volatile memory on the eSIM, wherein the value corresponds to a particular carrier profile and indicates that carrier profile is active.

Example 6. The method of any of examples 1-5, further including determining whether any carrier profile satisfies or violates the carrier personalization policy by comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier.

Example 7. The method of any of examples 1-6, in which the eSIM is an embedded universal integrated circuit card (eUICC).

Example 8. The method of any of examples 1-6, in which the eSIM is a multiple enabled profile (MEP)-capable circuit.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein but is to be accorded the widest scope consistent with the following claims and the principles and novel features disclosed herein.

What is claimed is:

1. A method for automated profile selection on a carrier-locked computing device, the method comprising:
detecting carrier profiles stored on an electronic subscriber identity module (eSIM); and
enabling use of the computing device with a carrier profile stored on the eSIM that satisfies a carrier personalization policy of the computing device in response to identifying an active carrier profile that violates the carrier personalization policy.

2. The method of claim 1, further comprising:
automatically deactivating any active carrier profile stored on the eSIM that violates the carrier personalization policy; and
notifying a user of the computing device that the carrier profile is being deactivated.

3. The method of claim 2, wherein automatically deactivating an active carrier profile that violates the carrier personalization policy includes setting a value in non-volatile memory on the eSIM, wherein the value corresponds to a particular carrier profile and indicates that carrier profile is inactive.

4. The method of claim 1, further comprising:
automatically activating any inactive carrier profile stored on the eSIM that satisfies the carrier personalization policy.

5. The method of claim 4, wherein automatically activating an inactive carrier profile that satisfies to the carrier personalization policy includes storing a value in non-volatile memory on the eSIM, wherein the value corresponds to a particular carrier profile and indicates that carrier profile is active.

6. The method of claim 1, further comprising determining whether any carrier profile satisfies or violates the carrier personalization policy by comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier.

7. The method of claim 1, wherein the eSIM is an embedded universal integrated circuit card (eUICC).

8. The method of claim 1, wherein the eSIM is a multiple enabled profile (MEP)-capable circuit.

9. A computing device, comprising:
a processor configured to:
detect carrier profiles stored on an electronic subscriber identity module (eSIM); and
enable use of the computing device with a carrier profile stored on the eSIM that satisfies a carrier personalization policy in response to identifying an active carrier profile that violates the carrier personalization policy.

10. The computing device of claim 9, wherein the processor is further configured to:
automatically deactivate any active carrier profile stored on the eSIM that violates the carrier personalization policy; and
notify a user of the computing device that that carrier profile is being deactivated.

11. The computing device of claim 10, wherein the processor is further configured to set a value in non-volatile memory on the eSIM that corresponds to a particular carrier profile and indicates that carrier profile is inactive as part of automatically deactivating an active carrier profile that violates the carrier personalization policy.

12. The computing device of claim 9, wherein the processor is further configured to automatically activate any inactive carrier profile stored on the eSIM that satisfies the carrier personalization policy.

13. The computing device of claim 12, wherein the processor is further configured to set a value in non-volatile memory on the eSIM that corresponds to a particular carrier profile and indicates that carrier profile is active as part of automatically activating an inactive carrier profile that satisfies to the carrier personalization policy.

14. The computing device of claim 9, wherein the processor is further configured to determine whether any carrier profile satisfies or violates the carrier personalization policy by comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier.

15. The computing device of claim 9, wherein the eSIM is an embedded universal integrated circuit card (eUICC) of the computing device.

16. The computing device of claim 9, wherein the eSIM is a multiple enabled profile (MEP)-capable circuit of the computing device.

17. A computing device, comprising:
means for detecting carrier profiles stored on an electronic subscriber identity module (eSIM); and
means for enabling use of the computing device with a carrier profile stored on the eSIM that satisfies a carrier personalization policy in response to identifying an active carrier profile that violates the carrier personalization policy.

18. The computing device of claim 17, further comprising:
means for automatically deactivating any active carrier profile stored on the eSIM that violates the carrier personalization policy; and
means for notifying a user of the computing device that that carrier profile is being deactivated.

19. The computing device of claim 18, further comprising means for setting a value in non-volatile memory on the eSIM that corresponds to a particular carrier profile and indicates that carrier profile is inactive as part of automatically deactivating an active carrier profile that violates the carrier personalization policy.

20. The computing device of claim 17, further comprising:
means for automatically activating an inactive carrier profile stored on the eSIM that satisfies the carrier personalization policy.

21. The computing device of claim 20, further comprising means for setting a value in non-volatile memory on the eSIM that corresponds to a particular carrier profile and indicates that carrier profile is active as part of automatically activating an inactive carrier profile that satisfies to the carrier personalization policy.

22. The computing device of claim 17, further comprising:
means for determining whether any carrier profile satisfies or violates the carrier personalization policy by comparing one or more attributes of each carrier profile with the carrier personalization policy, the one or more attributes including one or more of: an international mobile subscriber identity (IMSI), an international mobile equipment identity (IMEI), a multi-connectivity (MC) codea mobile country code (MCC), a mobile network code (MNC), a carrier identifier, or a subscriber identifier.

23. The computing device of claim 17, wherein the eSIM is an embedded universal integrated circuit card (eUICC) of the computing device.

24. The computing device of claim 17, wherein the eSIM is a multiple enabled profile (MEP)-capable circuit of the computing device.

25. A non-transitory processor-readable medium having stored thereon configured to cause a processor of a computing device to perform operations comprising:
detecting carrier profiles stored on an electronic subscriber identity module (eSIM); and
enabling use of the computing device with a carrier profile stored on the eSIM that satisfies a carrier personalization policy in response to identifying an active carrier profile that violates the carrier personalization policy.

26. The non-transitory processor-readable medium of claim 25, wherein the stored processor-executable instructions are further configured to cause the processor to automatically deactivate any active carrier profile stored on the eSIM that violates the carrier personalization policy and notify a user of the computing device that that carrier profile is being deactivated.

27. The non-transitory processor-readable medium of claim 26, wherein the stored processor-executable instructions are further configured to cause the processor to set a value in non-volatile memory on the eSIM that corresponds to a particular carrier profile and indicates that carrier profile is inactive as part of automatically deactivating an active carrier profile that violates the carrier personalization policy.

28. The non-transitory processor-readable medium of claim 25, wherein the stored processor-executable instructions are further configured to cause the processor to automatically activate an inactive carrier profile stored on the eSIM that satisfies the carrier personalization policy.

29. The non-transitory processor-readable medium of claim 28, wherein the stored processor-executable instructions are further configured to cause the processor to set a value in non-volatile memory on the eSIM that corresponds to a particular carrier profile and indicates that carrier profile is active as part of automatically activating an inactive carrier profile that satisfies to the carrier personalization policy.

30. The non-transitory processor-readable medium of claim 25, wherein the stored processor-executable instructions are further configured to cause the processor to determine whether any carrier profile satisfies or violates the carrier personalization policy by comparing one or more attributes of each carrier profile with the carrier personalization policy, the one or more attributes including one or more of: an international mobile subscriber identity (IMSI), a mobile country code (MCC), a mobile network code (MNC), a carrier identifier, or a subscriber identifier.
